(19) United States
(12) Patent Application Publication
(10) Pub. No.: US 2026/0138390 A1
(43) Pub. Date: May 21, 2026

(54) SENSORY STIMULATION PEN

(71) Applicant: Katelyn Tambornini, Portland, OR (US)

(72) Inventor: Katelyn Tambornini, Portland, OR (US)

(21) Appl. No.: 18/954,708

(22) Filed: Nov. 21, 2024

(51) Int. Cl. A61M 21/02; A61M 21/00; B43K 31/00

(52) U.S. Cl. CPC B43K 31/00; B43K 7/005

(57) ABSTRACT

A sensory stimulation pen includes a barrel, a tip, an ink chamber, a dispenser, and a plurality of tactile devices. The barrel includes a plurality of barrel sections detachably coupled together. Each of the barrel sections includes a first coupler positioned at a first end and a second coupler positioned at a second end opposite to the first end. The first coupler of each of the barrel sections is designed to detachably couple to the second coupler of any other one of the barrel sections such that a total number of barrel sections is selectively adjustable and relative positioning of the barrel sections of the barrel is selectively adjustable. The tactile devices are positioned on the barrel to provide tactile sensory stimulation to a user. Each of the barrel sections is connected to an associated one of the tactile devices.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to sensory devices and more particularly pertains to a new sensory stimulation pen for providing multiple configurations that can be changed as desired by the user. The sensory stimulation pen utilizes a modular barrel that has barrel sections that can be taken apart and re-arranged, or can be replaced with barrel sections having different tactile devices.

### (2) Description of Related Art Including Information Disclosed Under 37 CFR 1.97 and 1.98.

The prior art relates to sensory devices, such as pens and other writing implements that incorporate tactile devices, also known as fidget devices. The prior art, as best understood, does not disclose a sensory stimulation pen that include a barrel that has barrel sections that can be taken apart and re-arranged, or can be replaced with barrel sections having different tactile devices.

### (H) BRIEF SUMMARY OF THE INVENTION

An embodiment of the disclosure meets the needs presented above in a sensory stimulation pen generally comprising a barrel, a tip, an ink chamber, a dispenser, and a plurality of tactile devices. The barrel includes a plurality of barrel sections detachably coupled together. Each of the barrel sections includes a first coupler positioned at a first end and a second coupler positioned at a second end opposite to the first end. The first coupler of each of the barrel sections is designed to detachably couple to the second coupler of any other one of the barrel sections such that a total number of barrel sections is selectively adjustable and relative positioning of the barrel sections of the barrel is selectively adjustable. The tip is detachably coupled to the barrel. The tip includes an aperture at an end of the tip. The ink chamber is positioned in the barrel. The dispenser is coupled to the ink chamber. The dispenser is designed to project out through the aperture in the tip. The tactile devices are positioned on the barrel to provide tactile sensory stimulation to a user. Each of the barrel sections is connected to an associated one of the tactile devices.

There has thus been outlined, rather broadly, the more important features of the disclosure in order that the detailed description thereof that follows may be better understood, and in order that the present contribution to the art may be better appreciated.

There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWINGS (s)

The disclosure will be better understood and objects other than those set forth above will become apparent when consideration is given to the following detailed description thereof. Such description makes reference to the annexed drawings wherein:

FIG. 1 is a front view of a sensory stimulation pen according to an embodiment of the disclosure.

FIG. 2 is a side view of an embodiment of the disclosure.

FIG. 3 is a back view of an embodiment of the disclosure.

FIG. 4 is an exploded view of an embodiment of the disclosure.

FIG. 5 is a side cross-sectional view of an embodiment of the disclosure.

FIG. 6 is a side view of an embodiment of the disclosure in use.

### (j) DETAILED DESCRIPTION OF THE INVENTION

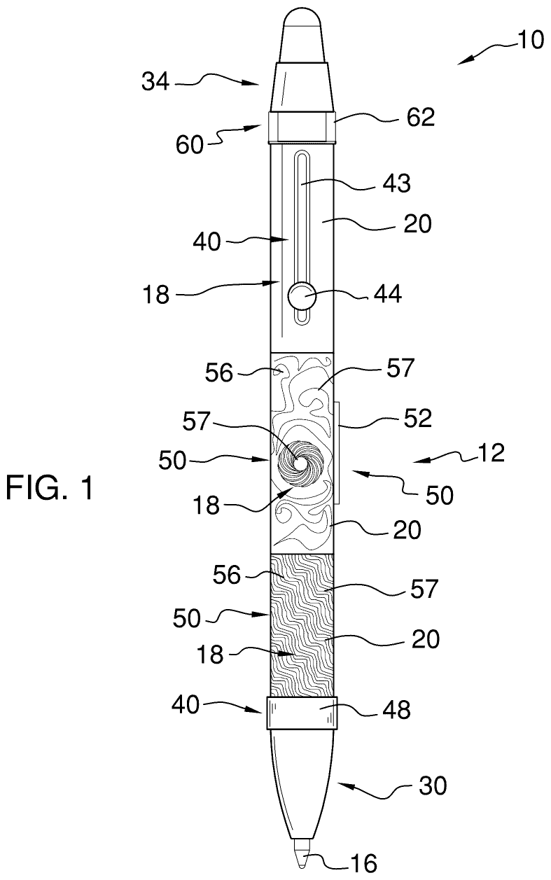

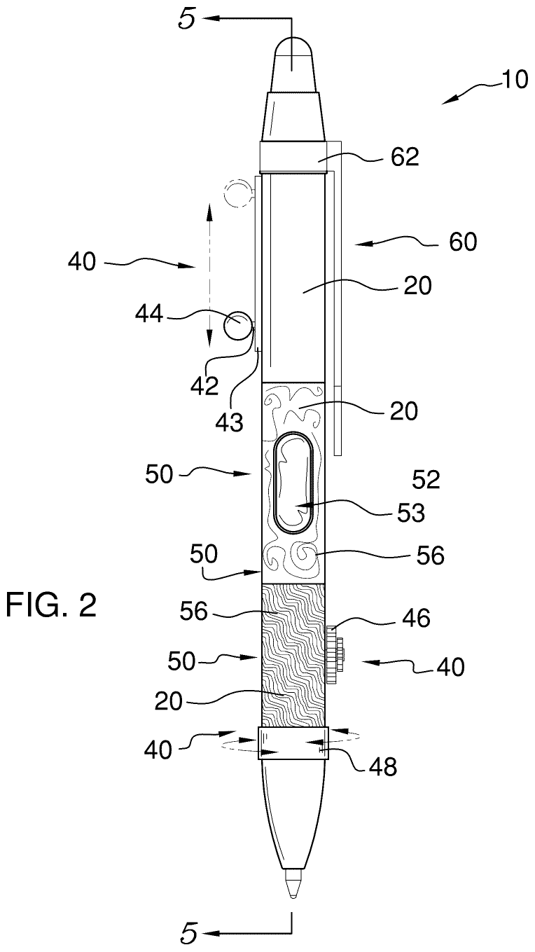

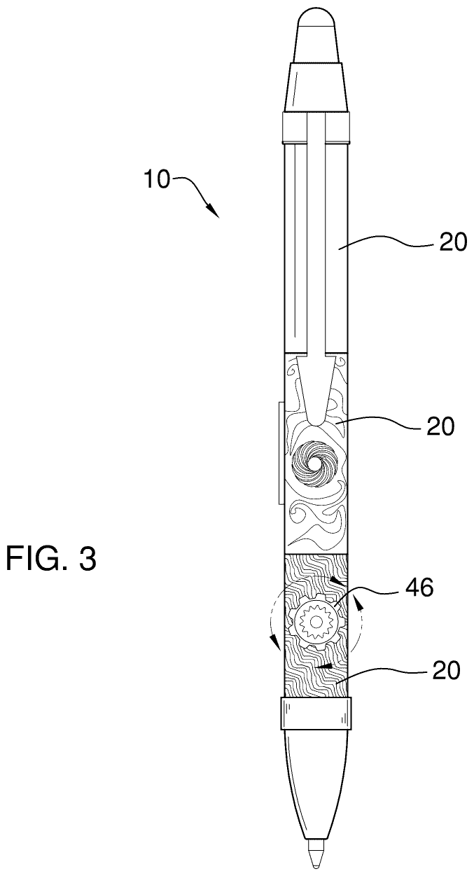

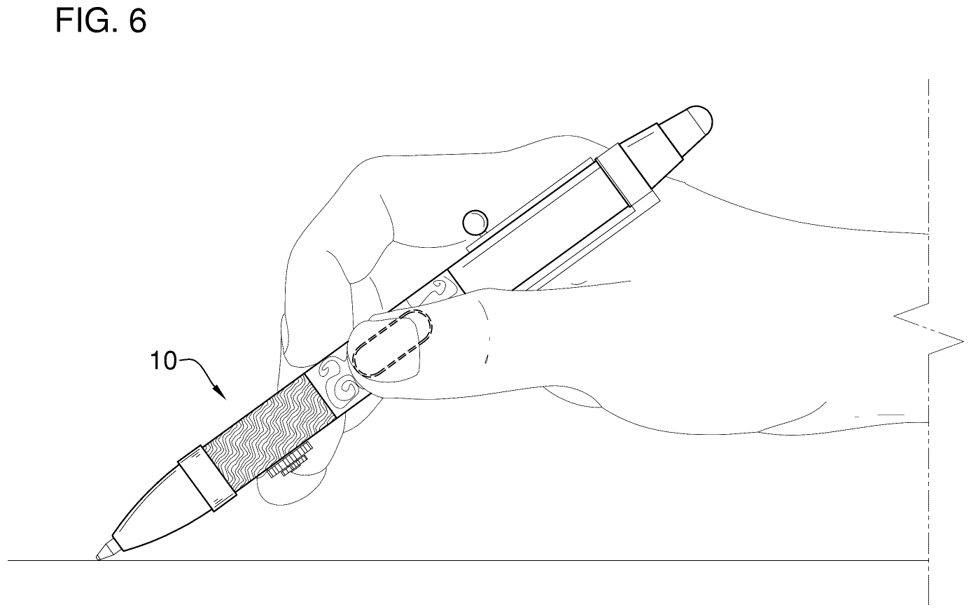

With reference now to the drawings, and in particular to FIGS. 1 through 6 thereof, a new sensory stimulation pen embodying the principles and concepts of an embodiment of the disclosure and generally designated by the reference numeral 10 will be described.

As best illustrated in FIGS. 1 through 6, the sensory stimulation pen 10 generally comprises a barrel 12, a tip 30, an ink chamber 14, a dispenser 16, and a plurality of tactile devices 18. The barrel 12 includes a plurality of barrel sections 20 detachably coupled together. Each of the barrel sections 20 includes a first coupler 22 positioned at a first end 24 and a second coupler 26 positioned at a second end 28 opposite to the first end 24. The first coupler 22 of each of the barrel sections 20 is designed to detachably couple to the second coupler 26 of any other one of the barrel sections 20 such that a total number of barrel sections 20 is selectively adjustable and relative positioning of the barrel sections 20 of the barrel 12 is selectively adjustable. The tip 30 is detachably coupled to the barrel 12. The tip 30 includes an aperture 32 at an end of the tip 30. The ink chamber 14 is positioned in the barrel 12. The dispenser 16 is coupled to the ink chamber 14. The dispenser 16 is designed to project out through the aperture 32 in the tip 30. The tactile devices 18 are positioned on the barrel 12 to provide tactile sensory stimulation to a user. Each of the barrel sections 20 is connected to an associated one of the tactile devices 18.

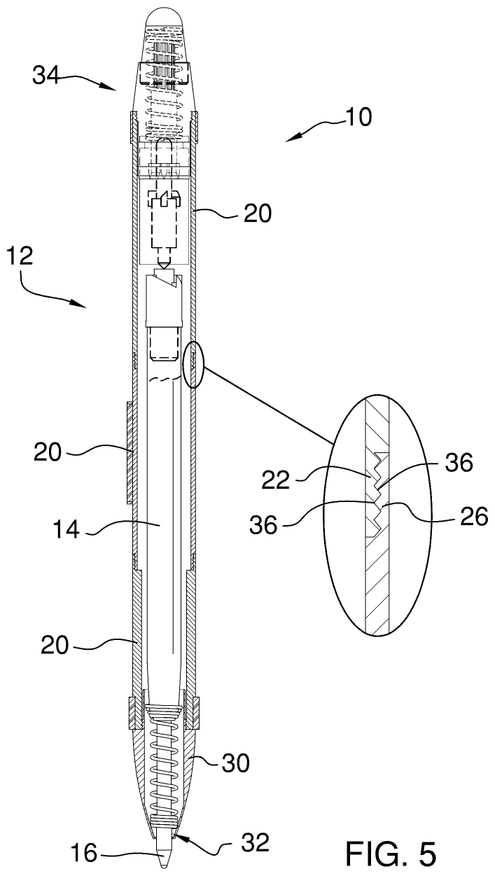

As shown in FIG. 5, the sensory stimulation pen 10 has a common design of a ballpoint pen, wherein there is a clicker portion 34, which is a spring-loaded thrust assembly that moves the ink chamber 14 and dispenser 16, such as a ballpoint nib, back and forth. This design is relatively standard and well known in writing technology. While a ballpoint pen design is shown in the figures, the inventive barrel 12 could be utilized in a mechanical pencil or other writing implements that include an outer shell.

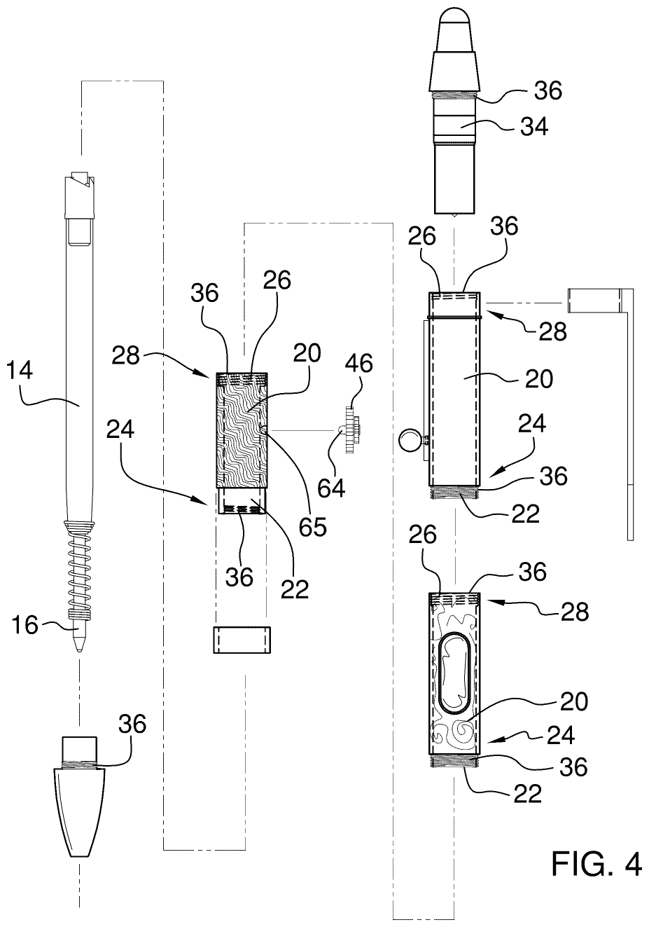

As shown in FIG. 4, the sensory stimulation pen 10 is designed to be taken apart and put back together. Each of the barrel sections 20 in the exemplary embodiment is connected by a screw threading 36, as shown in the close up view in FIG. 5. In the exemplary embodiment in FIG. 4, the first coupler 22 and the second coupler 26 could be a male or female screw portion, as needed for connections, though other connection styles are possible, such as snaps or clips. This allows a user to re-arrange the order of the barrel sections 20 as desired. In addition, the user can add and remove one or more of the barrel sections 20, which allows the user to alter the length of the barrel 12 and change the types of barrel sections 20. Such a modular design allows the user to vary the tactile sensory stimulation as desired. For example, the user could have a supply of additional barrel sections 20 of varying designs that could be swapped in and out as desired, thereby providing the user with a large number of customizable designs. It should be noted at this point that the exemplary embodiment in the figures shows the sensory stimulation pen 10 including various types of barrel sections 20 with different types and combinations of tactile devices 18. However, the sensory stimulation pen 10 shown is only one possible example, and other design variations are within the scope of the disclosure.

For example, as can be seen in FIG. 1, two of the tactile devices 18 are positioned on a respective one of the barrel sections 20. One of the two tactile devices 18 is designed to be manipulated in a different manner from another of the two tactile devices 18. The barrel section 20 connected to the clicker portion 34 of the sensory stimulation pen 10 is an example of this configuration. In addition, three of the tactile devices 18 are positioned on a respective one of the barrel sections 20. Each of the three tactile devices 18 is designed to be manipulated in a different manner from each other of the three tactile devices 18. The barrel section 20 connected to the tip 30 is an example of this configuration.

In the exemplary embodiment in FIG. 4, the barrel 12 includes three of the barrel sections 20. Each of the three barrel sections 20 is connected to a respective one of three of the tactile devices 18. Each of the three tactile devices 18 is designed to be manipulated in a different manner from each other of the three tactile devices 18. In other words, each of the three barrel sections 20 has a different type of the tactile devices 18. In one possible embodiment, four or more of the barrel sections 20 could be used.

Each of the tactile devices 18 is designed to be manually engaged without producing audible noise. Many fidget devices currently make noise. However, this can be undesirable in social or business situations, so the exemplary embodiment of the sensory stimulation pen 10 utilizes essentially silent versions of the tactile devices 18. However, in one possible embodiment, other devices could be used that produce sound, or possibly even lights and other sensory stimuli.

The tactile devices 18, also commonly known as fidget devices, are well known in the sensory device arts. The sensory stimulation pen 10 is designed to include any combination of different types of tactile devices 18. The exemplary embodiment in the figures shows three different types of tactile devices 18: a movable sensory device 40, a stationary sensory device 50, and a detachable sensory device 60. Some of the tactile devices 18 could also be a combination of these three types, such as a movable device that is also detachable. There are different examples of these specific types of tactile devices 18 shown in figures, as will be discussed in the following.

The movable sensory device 40 is attached to an associated one of the barrel sections 20. The movable sensory device 40 is designed to be selectively manually moved with respect to its associated one of the barrel sections 20. One movable sensory device 40 is an arm 42 slidably mounted in a track 43 positioned in its associated one of the barrel sections 20. The arm 42 includes a head 44 projecting out of the track 43. The head 44 is designed to be manually engaged to move the arm 42 along the track 43. Another movable sensory device 40 is a gear 46 rotatably coupled to its associated one of the barrel sections 20. As shown in FIG. 4, the gear 46 is also detachable, though it could be permanently attached. Yet another movable sensory device 40 is a washer 48 positioned about its associated one of the barrel sections 20. The washer 48 is manually rotatable or spinnable about its associated one of the barrel sections 20.

The stationary sensory device 50 is attached to an associated one of the barrel sections 20 in a fixed position. The stationary sensory device 50 is designed to be selectively and repetitively touched. One stationary sensory device 50 is a protrusion 52 positioned on its associated one of the barrel sections 20. The protrusion 52 includes resiliently deformable material 53, such as, for example, a foam or gel pack. Another stationary sensory device 50 is a layer 56 positioned on its associated one of the barrel sections 20. The layer 56 includes projecting ridges 57. The layer 56 could be a resilient material or a stiff material, such as an elastomer or a plastic or possibly even metal.

The detachable sensory device 60 is detachably coupled to an associated one of the barrel sections 20. The detachable sensory device 60 is designed to be selectively manually detached from and re-attached to its associated one of the barrel sections 20. One detachable sensory device 60 is a c-shaped clip 62 detachably coupled about its associated one of the barrel sections 20. The c-shaped clip 62 is resiliently flexible to permit attachment in a snap-fit manner. The example shown is a traditional clip for hooking pens on a shirt pocket or similar, though other clip-on structures could possibly be used. Another detachable sensory device 60 is a pin 64 detachably coupled in a receptacle 65 in its associated one of the barrel sections 20. As mentioned above, the gear 46 has such design, where the pin 64 projects out of the gear 46 like an axle and inserts into the receptacle 65 in the barrel section 20.

As mentioned above, the preceding are examples of different types of tactile devices 18 that could be used in a possible embodiment of the sensory stimulation pen 10. More than one of these tactile devices 18 can be positioned on an individual one of the barrel sections 20.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A sensory stimulation pen comprising:
a barrel, said barrel including a plurality of barrel sections detachably coupled together, each of said barrel sections includes a first coupler disposed at a first end and a second coupler disposed at a second end opposite to said first end, said first coupler of each of said barrel sections is configured to detachably couple to said second coupler of any other one of said barrel sections such that a total number of barrel sections is selectively adjustable and relative positioning of said barrel sections of said barrel is selectively adjustable;
a tip being detachably coupled to said barrel, said tip including an aperture at an end of said tip;
an ink chamber being disposed in said barrel;
a dispenser coupled to said ink chamber, said dispenser being configured to project out through said aperture in said tip; and
a plurality of tactile devices being disposed on said barrel to provide tactile sensory stimulation to a user, each of said barrel sections being connected to an associated one of said tactile devices, wherein said plurality of tactile devices includes two of said tactile devices each being disposed on a respective one of said barrel sections such that each of said two of said tactile devices are simultaneously disposed on said barrel.

2. (canceled)

3. The sensory stimulation pen of claim 1, wherein one of said two tactile devices is configured to be manipulated in a different manner from another of said two tactile devices.

4. The sensory stimulation pen of claim 1, wherein said plurality of tactile devices includes a third tactile devices being disposed on a respective one of said barrel sections such that each of said two of said tactile devices and said third tactile device are simultaneously disposed on said barrel.

5. The sensory stimulation pen of claim 4, wherein said third tactile devices is configured to be manipulated in a different manner from each of said two of said tactile devices.

6. The sensory stimulation pen of claim 1, wherein said barrel includes three of said barrel sections.

7. The sensory stimulation pen of claim 6, wherein:
each of said three barrel sections is connected to a respective one of three of said tactile devices such that each of said three of said tactile devices is simultaneously positioned on said barrel; and
each of said three tactile devices is configured to be manipulated in a different manner from each other of said three tactile devices.

8. The sensory stimulation pen of claim 1, wherein:
said tactile devices include a movable sensory device;
said movable sensory device is attached to an associated one of said barrel sections; and
said movable sensory device is configured to be selectively manually moved with respect to its associated one of said barrel sections.

9. The sensory stimulation pen of claim 8, wherein:
said movable sensory device is an arm slidably mounted in a track disposed in its associated one of said barrel sections;
said arm includes a head projecting out of said track; and
said head is configured to be manually engaged to move said arm along said track.

10. The sensory stimulation pen of claim 8, wherein said movable sensory device is a gear rotatably coupled to its associated one of said barrel sections.

11. The sensory stimulation pen of claim 8, wherein:
said movable sensory device is a washer disposed about its associated one of said barrel sections; and
said washer is manually rotatable about its associated one of said barrel sections.

12. The sensory stimulation pen of claim 1, wherein:
said tactile devices include a stationary sensory device;
said stationary sensory device is attached to an associated one of said barrel sections in a fixed position; and
said stationary sensory device is configured to be selectively and repetitively touched.

13. The sensory stimulation pen of claim 12, wherein:
said stationary sensory device is a protrusion disposed on its associated one of said barrel sections; and
said protrusion includes resiliently deformable material.

14. The sensory stimulation pen of claim 12, wherein:
said stationary sensory device is a layer disposed on its associated one of said barrel sections; and
said layer includes projecting ridges.

15. The sensory stimulation pen of claim 1, wherein:
said tactile devices include a detachable sensory device;
said detachable sensory device is detachably coupled to an associated one of said barrel sections; and
said detachable sensory device is configured to be selectively manually detached from and re-attached to its associated one of said barrel sections.

16. The sensory stimulation pen of claim 15, wherein:
said detachable sensory device is a C-shaped clip detachably coupled about its associated one of said barrel sections; and
said C-shaped clip is resiliently flexible to permit attachment in a snap-fit manner.

17. The sensory stimulation pen of claim 15, wherein said detachable sensory device is a pin detachably coupled in a receptacle in its associated one of said barrel sections.

18. The sensory stimulation pen of claim 1, wherein each of said tactile devices is configured to be manually engaged without producing audible noise.

19. The sensory stimulation pen of claim 8, wherein:
said tactile devices include a stationary sensory device;
said stationary sensory device is attached to an associated one of said barrel sections in a fixed position; and
said stationary sensory device is configured to be selectively and repetitively touched.

20. The sensory stimulation pen of claim 19, wherein:
said tactile devices include a detachable sensory device;
said detachable sensory device is detachably coupled to an associated one of said barrel sections; and
said detachable sensory device is configured to be selectively manually detached from and re-attached to its associated one of said barrel sections.
